(19) United States
(12) Patent Application Publication
(10) Pub. No.: US 2008/0128540 A1
(43) Pub. Date: Jun. 5, 2008

(54) MAGNETIC TAPE WINDING APPARATUS AND MAGNETIC TAPE WINDING METHOD

(75) Inventor: Takayuki SUZUKI, Odawara-shi (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 11/938,321

(22) Filed: Nov. 12, 2007

(30) Foreign Application Priority Data
Nov. 13, 2006 (JP) 2006-306523

(51) Int. Cl. G11B 15/66

(52) U.S. Cl. 242/332.3

(57) ABSTRACT

A magnetic tape winding apparatus includes: a winding portion that winds a magnetic tape by running the magnetic tape in a longitudinal direction; and an air blowing unit that blows air to a surface of the magnetic tape so as to vary a position of the magnetic tape to be wound.

### BACKGROUND OF THE INVENTION

1. Field of the Invention

The present invention relates to a magnetic tape winding apparatus and method enabled to prevent an edge of magnetic tape from being bent to cause a trouble at recording/reproducing.

2. Background Art

Magnetic tape cartridges complying with the LTO (Linear Tape Open) standard and the DLT (Digital Linear Tape) standard have hitherto been known as external recording media for data backup in a computer or the like. A process of manufacturing a magnetic tape cartridge is performed as follows. First, a servo signal is written to material magnetic tape by a servo writer. Subsequently, the magnetic tape is wound around a tape reel by a tape winding apparatus. Then, the tape reel is assembled to a cassette case. Thus, the process of manufacturing a magnetic tape cartridge is completed (see, e.g., JP-A-2002-74892 (the term “JP-A” as used herein means an “unexamined published Japanese patent application”) described below).

FIG. 11 is a cross-sectional view illustrating a state in which magnetic tape is wound around a tape reel. When magnetic tape T is wound around a tape reel 100, the magnetic tape T is set in the winding apparatus. Then, the magnetic tape T is wound at high speed by a machine reel or the like. However, when the magnetic tape T is wound by the winding apparatus, the magnetic tape T may be deviated in a width direction due to occurrence of winding-disarrangement. Then, a protruding part P of the magnetic tape T may be brought into contact with the inner side surface of one (e.g., an upper reel flange 102 shown in FIG. 11) of reel flanges. Thus, the protruding part P may be bent. Accordingly, for example, JP-A-61-51642 and JP-A-2005-228434 have proposed methods of winding magnetic tape along the inner side surface of a lower reel flange 101 of a tape reel 100 so as to put into a state in which the magnetic tape T is neatly wound around the tape reel 100 (i.e., what is called neat-winding of the magnetic tape T is performed).

In recent years, there has been an increasing demand for a magnetic tape cartridge having high recording capacity. High recording capacity has been assured by reducing the thickness of magnetic tape so as to increase the number of turns of the magnetic tape wound around a tape reel. However, there is room for improvement in that the reduction in the thickness of magnetic tape makes it more difficult to wind, when the magnetic tape is wound around the tape reel, the magnetic tape without causing winding-disarrangement of the magnetic tape, and in that a protruding portion is easily bent in a state in which the magnetic tape is wound therearound.

### SUMMARY OF THE INVENTION

The invention is accomplished in view of the aforementioned circumstances. An object of the invention is to provide a magnetic tape winding apparatus and method, which are enabled to prevent magnetic tape wound around a tape reel from butting against a reel flange and being bent.

To achieve the foregoing object of the invention, according to an aspect of the invention, there is provided a winding apparatus for winding magnetic tape, which is featured by comprising a winding portion adapted to wind the magnetic tape by running the magnetic tape in a longitudinal direction, and air blowing means adapted to blow air to a surface of the magnetic tape to thereby vary a position of the magnetic tape to be wound.

Also, to achieve the foregoing object of the invention, according to an aspect of the invention, there is provided a winding method for winding magnetic tape, which is featured by comprising an air-blowing step of varying a position of the magnetic tape, which is to be wound, by blowing air to a surface of the magnetic tape while winding the magnetic tape by running the magnetic tape in a longitudinal direction.

According to the invention, the position, in which the magnetic tape is wound, is varied by blowing air to the magnetic tape when magnetic tape is wound. Thus, the wound magnetic tape is put into an unneatly arranged winding shape. Then, the position in the magnetic tape wound around the tape reel is brought into a wholly varied state. Consequently, a load due to the contact between the protruding part P and the reel flange can be prevented from being applied locally to the reel flange of the tape reel. Accordingly, when the magnetic tape is wound around the tape reel, the magnetic tape can be prevented from partly butting against the reel flange and being bent.

Preferably, the winding apparatus according to the invention has a perpendicular air-blowing portion configured to blow air substantially perpendicularly to a surface of the magnetic tape. Also, the winding method according to the invention has a substep of blowing air substantially perpendicular to a surface of the magnetic tape. Thus, when air blows against the surface of the magnetic tape, the position in the direction of width of the magnetic tape is deviated. This can cause variation in the position in the direction of width of the magnetic tape overlapping in a wound state.

Preferably, the winding apparatus has a parallel air-blowing portion configured to blow air substantially parallel to a surface of the magnetic tape. Also, the winding method according to the invention has a substep of blowing air substantially parallel to a surface of the magnetic tape. Thus, a phenomenon occurs, in which air is accompanied by the running magnetic tape. Flowing air is present in the vicinity of the magnetic tape. Consequently, the position in the direction of width of the magnetic tape having blown substantially perpendicular to the surface of the magnetic tape is likely to vary. This can cause variation in the position in the direction of width of the magnetic tape overlapping in a wound state.

In addition, the expression “the air substantially parallel to a surface of the magnetic tape” means “the air substantially parallel to at least one of a longitudinal and width direction of a surface of the magnetic tape.”

The invention can provide a magnetic tape winding apparatus and method, which are enabled to prevent magnetic tape wound around a tape reel from butting against a reel flange and being bent.

### BRIEF DESCRIPTION OF THE DRAWINGS

The invention disclosed herein will be understood better with reference to the following drawings of which:

FIG. 1 is an explanatory view illustrating the configuration of a magnetic tape winding apparatus according to an embodiment of the invention;

FIG. 2 is an explanatory view illustrating an operation of blowing air to magnetic tape;

FIG. 3 is a view illustrating the configuration of an air blowing means according to the embodiment;

FIG. 4 is a view illustrating the configuration of another air blowing means according to the embodiment;

FIG. 5 is a cross-sectional view schematically illustrating a state in which magnetic tape is wound around a tape reel;

FIG. 6 is a schematic view illustrating a servo signal region of magnetic tape;

FIG. 7 is a graph illustrating a state of winding of wound magnetic tape according to Comparative Example 1;

FIG. 8 is a graph illustrating a state of winding of wound magnetic tape according to Comparative Example 2;

FIG. 9 is a graph illustrating a state of winding of magnetic tape according to Example 1;

FIG. 10 is a graph illustrating a state of winding of wound magnetic tape according to Example 2; and

FIG. 11 is a cross-sectional view illustrating a state in which magnetic tape is wound around a tape reel.

### DETAILED DESCRIPTION OF THE INVENTION

Hereinafter, embodiments of the invention are described in detail with reference to the accompanying drawings.

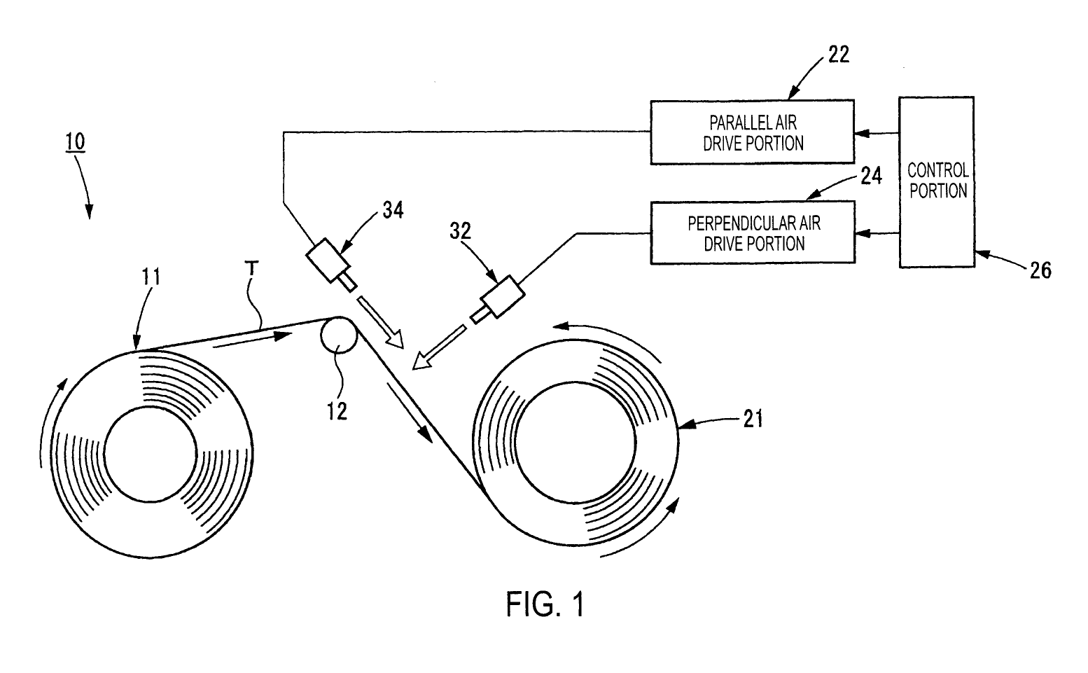

FIG. 1 is an explanatory view illustrating the configuration of a magnetic tape winding apparatus according to an embodiment of the invention.

Magnetic tape T is a long belt-like member having a magnetic layer to which magnetic information for performing magnetic recording/reproducing can be written. The constitution of the magnetic tape can be made to be similar to that of conventional magnetic tape. For example, a magnetic layer in which information can magnetically be recorded, a protection layer that protects the magnetic layer from deterioration and abrasion, and a lubricating layer adapted to improve running durability and corrosion resistance by providing a lubricant agent thereto are stacked in this order on one of surfaces of a support medium made of polyethylene terephthalate (PET) or polyethylene naphthalate (PEN) Additionally, a primer layer (not shown) for enhancing a surface nature and a gas barrier property, or a foundation layer for enhancing recording properties by controlling crystalline orientation can be provided on the surface of the support medium. Incidentally, a back coat layer is formed on a surface opposite to the magnetic layer through the support element. Generally, presently, the thickness T of the magnetic tape is about 6.6 μm. However, to meet the recent demand for a magnetic tape cartridge having high recording capacity, thinner magnetic tape is desired.

The magnetic tape T is usually accommodated in a cartridge case made a synthetic resin in a state in which the magnetic tape T is wound around a single tape reel. Then, the magnetic tape T is used in a magnetic tape cartridge complying with the predetermined standard. Thus, the magnetic tape T is used as a general-purpose magnetic recording medium. In a case where the magnetic tape T in the magnetic tape cartridge is loaded into a drive unit. Then, the magnetic tape T is drawn out by a loading member incorporated in the drive unit, and is wound around a machine reel. Also, magnetic information is written to or read from the magnetic layer of the magnetic tape T by a magnetic recording head. At that time, in a case where the magnetic tape T is drawn by the loading member directly therefrom, sufficient mechanical strength cannot be assured due to small thickness of the magnetic tape T. Accordingly, a leader tape connected to a leading end portion in a direction, in which the magnetic tape T is drawn, and formed sufficiently thick is drawn by the loading member.

The process of manufacturing a magnetic tape cartridge has a servo-write step of writing a servo signal to magnetic tape, a tape winding step of magnetic tape, on which the servo signal is written, around a tape reel, an assembling step of assembling a lower cartridge case to the tape reel, around which the magnetic tape is wound, and assembling also the lower cartridge case to an upper cartridge case, an inspection step of inspecting the magnetic tape cartridge after the magnetic tape cartridge is assembled, and an integration step of loading the inspected magnetic tape cartridge at a predetermined position. The winding apparatus according to the present embodiment is used in the tape winding step. In the other steps, devices used in an apparatus similar to those used in the conventional apparatuses.

As illustrated in FIG. 1, a winding apparatus 10 has a feed reel for feeding the magnetic tape T, a tape guide 12 for guiding the fed magnetic tape T, and a machine reel 21 around which the magnetic tape T is wound. In the present embodiment, the machine reel 21 functions as the winding portion. When the winding step is started, one end of the magnetic tape T is drawn out and is fixed to the machine reel 21. Then, the machine reel 21 is rotationally driven. Thus, the magnetic tape T runs to the machine reel 21 through the tape guide 12 from the feed reel 11, as indicated by black arrows. For example, a free roller can be used as the tape guide 12. A plurality of tape guides can be provided along the running path of the magnetic tape T.

The winding apparatus 10 has an air blowing means for blowing air to the magnetic tape T running when wound around the reel. More specifically, in the present embodiment, a perpendicular air blowing portion 32 which blows air substantially perpendicular to the surface of the magnetic tape T that runs, and a parallel air blowing portion 34 which blows air substantially parallel to the surface of the magnetic tape T, function as the air blowing means. The configuration of each of the perpendicular air blowing portion 32 and the parallel air blowing portion 34 will be described later.

The perpendicular blowing portion 32 is connected to a perpendicular air drive portion 24. The commencement and the termination of driving the perpendicular air blowing portion 32, an air blowing time and a quantity of flow of air can be controlled by controlling the perpendicular air drive portion 24.

The parallel air blowing portion 34 is connected to a parallel air drive portion 22. The commencement and the termination of driving the parallel air blowing portion 34, an air blowing time and a quantity of flow of air can be controlled by controlling the parallel air drive portion 22.

The winding apparatus 10 has a control portion 26. The control portion 26 outputs control signals to the parallel air drive portion 22 and the perpendicular air drive portion 24. Thus, a user can optionally regulate an air blowing operation of each of the perpendicular air blowing portion 32 and the parallel air blowing portion 34.

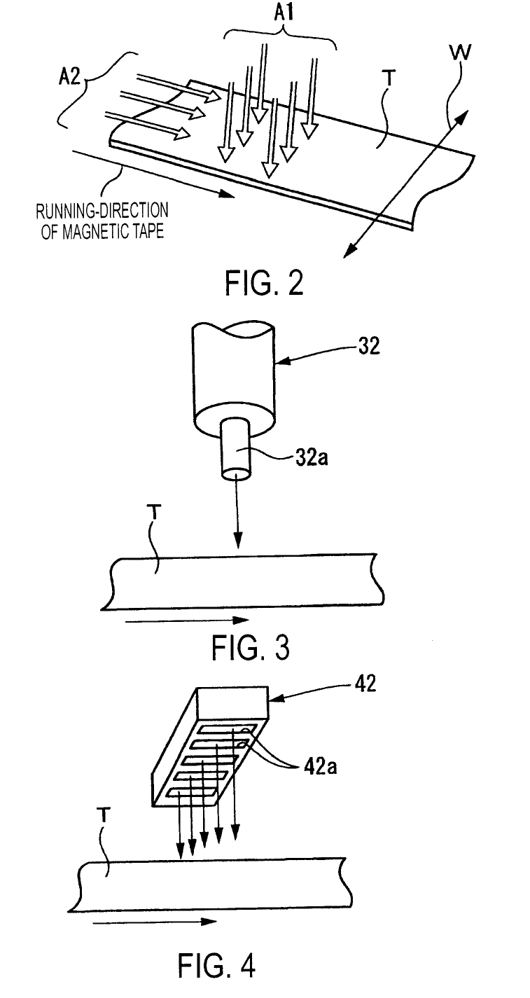

FIG. 2 is an explanatory view illustrating an operation of blowing air to magnetic tape.

When the air A1 is blown substantially perpendicular to the surface of the magnetic tape T, the magnetic tape T is deviated in the direction of width W thereof by the resistance generated by the air A having blown against the magnetic tape T. Thus, the magnetic tape T is wound around the machine reel while being deviated in the direction of width of the magnetic tape T. Consequently, the positions in the direction of width of turns of the wound magnetic tape T vary.

When the air A2 is blown substantially parallel to the magnetic tape T that runs, a phenomenon occurs, in which air is accompanied by the running magnetic tape T. Flowing air is present in the vicinity of the magnetic tape T. Consequently, the position in the direction of width of the magnetic tape having blown substantially perpendicular to the surface of the magnetic tape T is likely to vary. This can efficiently cause variation in the position in the direction of width of the magnetic tape overlapping in a wound state.

FIG. 3 is a view illustrating the configuration of an air blowing means according to the embodiment. As illustrated in FIG. 3, an air nozzle 32 has a mechanism for blowing air supplied from a nozzle port 32a of an air tank (not shown) at a predetermined rate. Air can continuously be blown out therefrom during the winding step for a predetermined time. Alternatively, air can intermittently be blown out therefrom. Although FIG. 3 illustrates the configuration in which the air nozzle is employed as the perpendicular air blowing portion, the parallel air blowing portion can be configured to be the same as the air nozzle 32.

FIG. 4 is a view illustrating the configuration of another air blowing means according to the embodiment. An air blowing member 42, in which air blowout openings 42a are formed like a lattice, can be used as the air blowing means. Preferably, the air blowout openings 42a are arranged at substantially uniform intervals in the direction of width of the magnetic tape T. Thus, air can be blown to the magnetic tape T at uniform pressure.

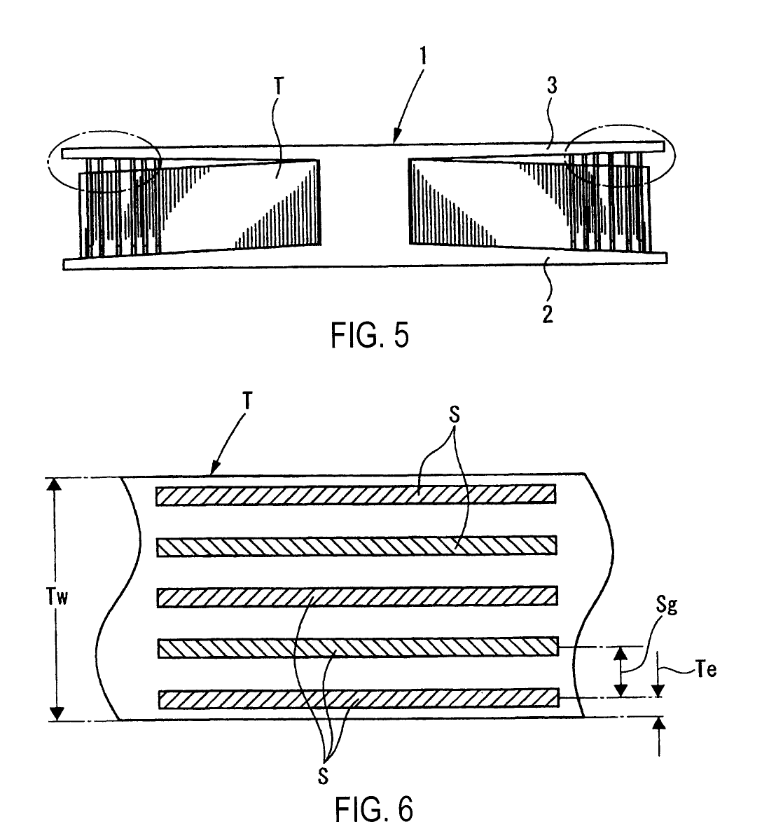

FIG. 5 is a cross-sectional view schematically illustrating a state in which magnetic tape is wound around a tape reel. The present embodiment causes variation in the positions in the width direction (e.g., the top and bottom positions, as viewed in FIG. 5) of turns of the wound magnetic tape T. Thus, the wound magnetic tape T is put into an unneatly arranged winding shape. Then, the position in the magnetic tape T wound around the tape reel 1 is brought into a wholly varied state. Consequently, in a case where the magnetic tape T is wound therearound by being drawn along the inner side surface of a lower reel flange 2 of the tape reel 1, other protruding parts of the magnetic tape T are present at the side of an upper reel flange 3 as indicated by ovals in FIG. 5. Accordingly, a load due to the contact between the upper reel flange 3 of the tape reel 1 and magnetic tape T can be prevented from being applied locally to the tape reel 1. Thus, when the magnetic tape T is wound around the tape reel 1, the magnetic tape T can be prevented from partly butting against the upper reel flange 3 and being bent.

According to the present embodiment, in a case where the magnetic tape T is wound in a varied state without being neatly wound, preferably, an end portion in the width direction of the magnetic tape T is wound along the inner side surface of the flange. Thus, even when an external force due to impact caused by dropping the magnetic tape cartridge is applied to the flange, the flange can be prevented from being deformed so that the end portion of the magnetic tape is folded.

FIG. 6 is a schematic view illustrating a servo signal region of LTO-Ultrium 3 magnetic tape.

A plurality of elongated belt-like servo signal regions S are formed at uniform intervals in the width direction of the magnetic tape T. Incidentally, the width dimension Tw of the magnetic tape T is about 12.65 mm. The width dimension of the servo signal region S is about 186 μm. The interval Sg between the servo signal regions S is about 2858.8 μm. The interval Te between each edge portion in the width direction of the magnetic tape T and an associated one of both end servo signal regions in the width direction is about 607.5 μm.

The method of winding magnetic tape according to the invention can preferably be implemented using the winding apparatus according to the present embodiment. The method of winding magnetic tape according to the invention has an air blowing step of varying the position of the magnetic tape, which is to be wound, by blowing air to the surface of the magnetic tape while the magnetic tape is made to run in the longitudinal direction. The air blowing step has a substep of blowing air substantially perpendicular to a surface of the magnetic tape. Additionally, the air blowing step can have a substep of blowing air substantially parallel to a surface of the magnetic tape.

### EXAMPLES

Next, examples according to the invention are described below.

The present example uses the magnetic tape winding apparatus described in the description of the embodiment. Incidentally, the magnetic tape used in the present example is for use in an LTO-type magnetic tape cartridge, and is obtained by winding thin tape having a predetermined length at low tension.

Air blowing conditions according to the present example are described in the following Table 1. In Table 1, “Parallel Air” is air blown from the parallel air blowing portion substantially parallel to the magnetic tape. Also, “Perpendicular Air” is air blown from the perpendicular air blowing portion substantially perpendicular to the magnetic tape. To clarify the advantages of the present example, Comparative Examples are provided by changing the air blowing conditions without changing other conditions. In the case of Comparative Example 1, the magnetic tape is wound by blowing neither parallel air nor perpendicular air. In the case of Comparative Example 2, the magnetic tape is wound by blowing only parallel air without blowing perpendicular air. In the case of Example 1, the magnetic tape is wound by blowing only perpendicular air without blowing parallel air. In the case of Example 2, the magnetic tape is wound by blowing both perpendicular air and parallel air.

TABLE 1

| | | Perpendicular | |
|---|---|---|---|
| | Parallel Air | Air | State of Winding |
| Comparative | Absent | Absent | Variation Is Absent |
| Example 1 | | | |
| Comparative | Present | Absent | Variation Is Absent |
| Example 2 | | | |
| Example 1 | Absent | Present | Variation Is Present |
| Example 2 | Present | Present | Variation Is Present |

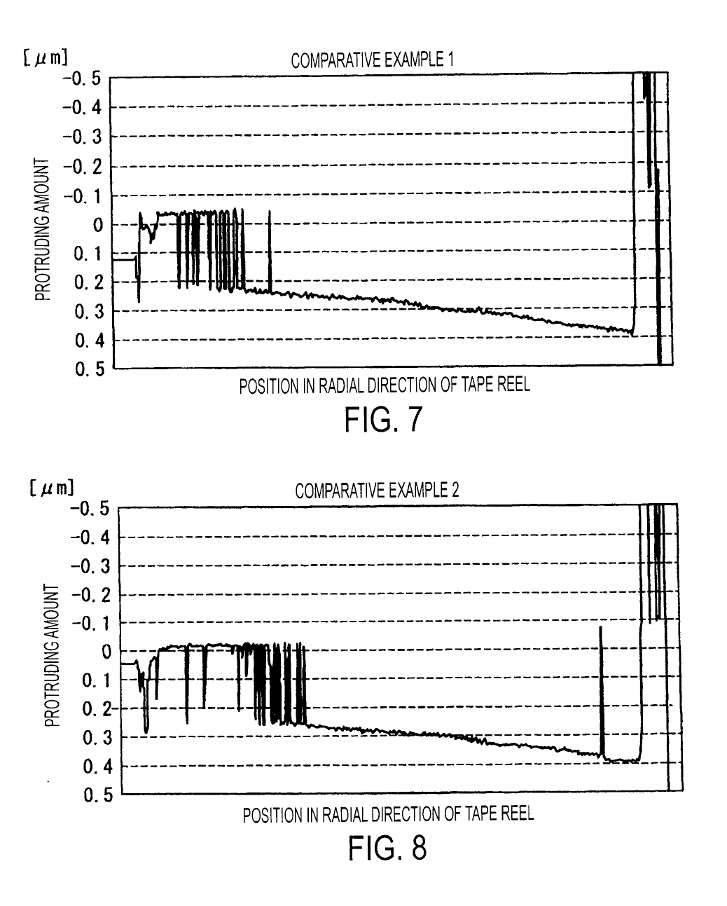

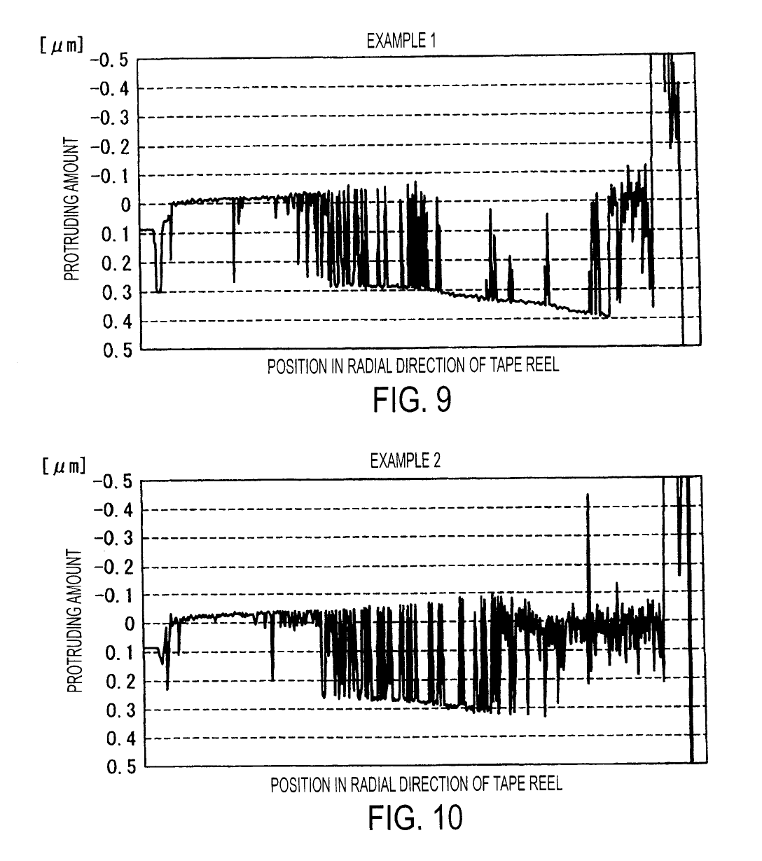

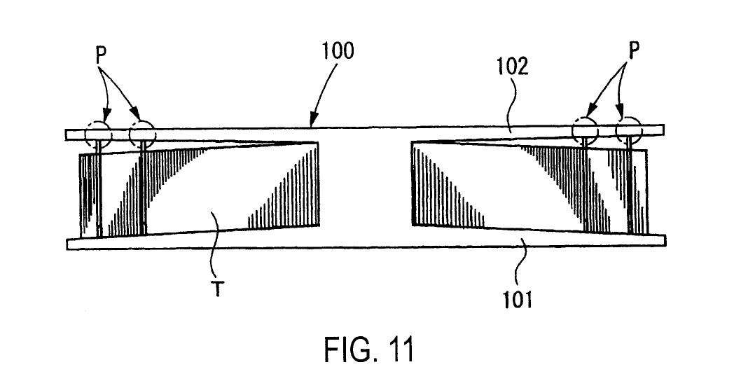

FIGS. 7 to 10 are graphs illustrating a state of winding of wound magnetic tape according to Comparative Example 1. Abscissas represent the radial position in the wound magnetic tape. Ordinates represent protruding amounts with respect to the width direction of the wound magnetic tape. FIG. 7 is a graph illustrating a state of winding of wound magnetic tape according to Comparative Example 1. FIG. 8 is a graph illustrating a state of winding of wound magnetic tape according to Comparative Example 2. FIG. 9 is a graph illustrating a state of winding of wound magnetic tape according to Example 1. FIG. 10 is a graph illustrating a state of winding of wound magnetic tape according to Example 2. In the case of Comparative Examples 1 and 2, no variation in the state of winding of the wound magnetic tape is present after the magnetic tape is wound. It is found that the magnetic tape is liable to bend due to the interference of the tape with the reel flange of the tape reel. In the case of Example 1, variation in the state of winding of the wound magnetic tape is present. It is found that the magnetic tape can be prevented from being bent due to the interference of the tape with the reel flange of the tape reel. In the case of Example 2, variation in the state of winding of the wound magnetic tape is large wholly. It is found that the magnetic tape can more surely be prevented from being bent due to the interference of the tape with the reel flange of the tape reel. According to the present examples, it is found that variation in the state of winding of the wound magnetic tape is caused by blowing at least perpendicular air from the perpendicular air blowing portion serving as the air blowing means, and that the wound magnetic tape becomes difficult to bend.

The present application claims foreign priority based on Japanese Patent Application (JP 2006-306523) filed Nov. 13 of 2006, the contents of which is incorporated herein by reference.

What is claimed is:

1. A magnetic tape winding apparatus comprising:
a winding portion that winds a magnetic tape by running the magnetic tape in a longitudinal direction; and
an air blowing unit that blows air to a surface of the magnetic tape so as to vary a position of the magnetic tape to be wound.

2. The magnetic tape winding apparatus as claimed in claim 1, wherein
the air blowing unit comprises:
a perpendicular air-blowing portion that blows air substantially perpendicularly to a surface of the magnetic tape.

3. The magnetic tape winding apparatus as claimed in claim 2, wherein
the air blowing unit comprises:
a parallel air-blowing portion that blows air substantially parallel to a surface of the magnetic tape.

4. A magnetic tape winding method comprising:
winding a magnetic tape by running the magnetic tape in a longitudinal direction; and
blowing air to a surface of the running magnetic tape so as to vary a position of the magnetic tape to be wound.

5. The magnetic tape winding method as claimed in claim 4, wherein the blowing of the air comprises blowing air substantially perpendicular to a surface of the magnetic tape.

6. The magnetic tape winding method as claimed in claim 5, wherein the blowing of the air comprises blowing air substantially parallel to a surface of the magnetic tape.
